(19) United States
(12) Patent Application Publication
(10) Pub. No.: US 2003/0017432 A1
(43) Pub. Date: Jan. 23, 2003

(54) Dental cortical plate guidance port

(76) Inventor: Arthur Kitchings Weathers JR., Griffin, GA (US)

Correspondence Address: Dr. Arthur K. Weathers, 14 Hudson Road, Griffin, GA, 30224, US

(21) Appl. No.: 09/906,472

(22) Filed: Jul. 17, 2001

(51) Int. Cl. A61C 17/00

(52) U.S. Cl. 433/80

(57) ABSTRACT

This application relates to both a method and a device for the initial and subsequent guidance of drills, hypodermic needles, or pressurized fluids into the cortical plate of human mandibular and maxillary bones. The invention comprises a dedicated channel through a positioning guide device that is optimized for use with an indexing or registration material to achieve a repeatable position for initial drilling and subsequent medication delivery procedures.

This application relates to the field of medicine, and more specifically involves corrective measures to improve the success of intraosseous medication injections in Dentistry and related fields requiring anaesthesia.

### DISCUSSION OF THE PRIOR ART

The art of deadening pain for the Dental industry was greatly improved by the discovery that smaller and more effective dosages of medication could be introduced beneath the cortical plate. Pivotally, U.S. Pat. No. 5,173,050 by Dillon in 1992 cited methods of and implements for drilling an initial perforation, thus allowing the dentist to remove the drill and re-enter the passageway with a hypodermic needle to deliver anaesthesia.

However, difficulties as taught by Dillon mainly involving failures of reentry caused the industry to respond with two U.S. Pat. Nos. 5,762,639 by Gibbs, and 5,779,708 by Wu, both describing methods to leave an intraosseous channel in place subsequent to drilling. This channel served as a guidance system to allow re-entry for medicative purposes.

Adversely, the necessity of hollow guidance sleeves to themselves be drills increased the expense over Dillon and introduced dangers involving incidents of breakage of the tiny-diameter, hollow implements. The threat of the breakage and subsequent successful retrieval of all foreign objects from the patient is complicated by the presence as taught by Gibbs and Wu of other separate and intricate inner plugging stylets or rods. These latter implements strengthen the overall shaft and block the backflow of bone chips and other organic matter while drilling. Also the health of the patient is subsequently put at risk by the open channel, which in some cases puts bacteria in open contact with the tissues beneath the bone for several hours.

Thus the introduction of bacteria from the air or contaminated water lines, the post recovery after inevitable failure of some instruments, and the more complicated nature of drill construction has dampened the success of the latter two patents. Because of the simplicity of the concept and the fact the Dillon apparatus allows the flesh around the perforation to seal the wound when no drill or needle is present, the commercial success and availability of this patent has flourished under the marketing name of the Stabident system. But the original complaint of difficult re-entry (for the Stabident system and other related prior art teaching such as the Villette injector) remains as a drawback for optimized delivery of medication.

Another pertinent negative to all three patents mentioned is the fact breakage of the drill or apparatus is prone to happen flush to the cortical plate. This is because the drill is hand held and success is dependent on the ability of the Dentist to maintain the angle of entry while penetrating the hard surface to reach the interior cancellous bone tissue. The patient may waver, the Dentist may move improperly, or the fabricating material may fail. The ability to retrieve the broken material is thus a serious issue.

### OBJECTS AND ADVANTAGES

It is therefore accordingly an object of the present invention to provide a guidance port exterior to the cortical plate that yields a short protruding stem to grasp and remove should breakage of the drill, needle, or delivery device occur, lessening the danger of drills, needles, or delivery devices being broken flush to the cortical plate and slightly beneath the gingiva.

It is further accordingly an object of the present invention to provide a guidance port exterior to the cortical plate that allows the use of a solid drill bit dedicated solely to the purpose of perforating bone.

It is further accordingly an object of the present invention to provide a guidance port exterior to the cortical plate to enable the angle of entry through the bone to be maintained as the penetrating drill passes through the bone, lessening the danger of breakage.

It is further accordingly an object of the present invention to provide a guidance port exterior to the cortical plate to enable the angle of entry through the bone to be maintained if a medicating needle is subsequently inserted through the bone which lessens the danger of breakage, or with backflow modifications the port can eliminate insertion of a needle through the perforated bone by the use of a pressurized fluid delivery medium.

It is further accordingly an object of the present invention to provide a guidance port exterior to the cortical plate to enable either a successful reentry or re-use of the orifice by either aligning the medicating needle tip back to the correct location lessening trauma to the gingiva, or resealing the drilled orifice for reuse of the fluid delivery medium.

It is further accordingly an object of the present invention to provide a guidance port exterior to the cortical plate heralded by a radio-opaque marker to enable the checking of the positioning of the contemplated penetration at the time of X-rays, lessening the danger of having to drill a second entry, and/or inflicting damage to an unsuspected curved root.

These and many other objects and advantages will be readily apparent to one skilled in the art to which the invention pertains from a perusal of the claims and the following detailed description of preferred embodiments when read in conjunction with the appended drawings.

### BACKGROUND OF THE INVENTION

After the gingiva is deadened, the placement of a guidance port exterior to, but flush against, the cortical plate allows the positioning of a preselected entry point for a drill. The contact side of the port may be slightly beveled to reflect the natural curvature of the gingiva covering the cortical plate. Spread over a webbed tray in common fashion that a patient bites down on, the use of an indexing material such as the various vulcanizing compounds like polyvinyl can be employed to coagulate and harden for instance around a preformed model held flush to the cortical plate. Within a minute the preformed model can be withdrawn from the firmed polyvinyl and replaced with the guidance port.

However in the preferred embodiment the guidance port is employed directly in lieu of the model although there are disadvantages to be overcome. The guidance port itself has a channel ending in a contact surface hole that can be occluded by polyvinyl. Secondly should polyvinyl even partially creep under the contact space, the port even after cleaning would not be perfectly flush with the gum when pre-embedded in the polyvinyl.

Therefore a dedicated holder bearing a thin stylus that can plug the hole and even extend a little beyond it is required to secure the port against the gingiva while the polyvinyl sets up around both the port and the tooth. The slight extension of the stylus is present to gently punch down against the soft gingiva as both a test to insure the patient feels no pain, and to anchor the port's contact surface from sliding inadvertently. This anchoring also allows a firm even pressure to be applied which defeats creep. The length of the extension can be engineered to protrude about a half a millimeter. The dedicated holder itself can be engineered to have a second end designed to screw into or connect with standard mirror handles or the like. Also the outer surface of the port should have numerous fin shaped protuberances designed to firmly anchor the port in the polyvinyl. This is because when a drill passes through the port it might spin with the drill if not secured.

The entry point can be heralded by a small amount of semi (or fully) radio-opaque material that is left behind when the preformed model is withdrawn from the polyvinyl, or alternately either introduced or attached at the time the guidance port replaces the model. Optimally the port itself is doped with a small amount of opaque particles such that an X-ray would create a faint bullseye effect on the film. A dentist can then do an X-ray of the subject tooth as usual, but also have the alignment hole appear on the X-ray film as a small unfogged circle and confirm the position. Otherwise as is sometimes the case in intraosseous drilling, a crowded, curved, or deformed root may be struck with subsequent unwarranted damage to the ligaments or to the tooth itself, exposing it to infection.

The guidance port thus uses fast hardening two-component impression material such as medical grade polyvinyls which may be placed as mentioned while viscous over a tooth. These polyvinyls are available in clear uncolored varieties and are designed to receive the bite and create the indexed surface within a forty second set time. The subsequent ability of an indexed system to accurately reposition the port (by being placed back upon the subject teeth) eliminates the probing and searching associated with the Stabident and other nonguided systems when the pain is returning and the patient needs more nerve deadening. This is true especially in the extremely posterior positions on the lingual (or tongue) side where the Dentist may have to otherwise search for the tiny hole with a mirror.

The section of the preformed channel in the guidance port closest to the gums should ideally be evenly cylindrical, however the presence of a gentle flaring of the hole's size as the outer edge is reached encourages three desirable results. First the flared hole is easier to insert a drill bit or needle into; second the flaring allows a quick blast of water to flush out any chips of bone left in the port; and third if there is breakage then it tends to happen at the point where the flaring begins rather than at the gumline. Thus the physical presence of the guidance port directly against the gingiva in almost all cases ensures that if a break of the drill or needle occurs, after removal of the port there will be an elevated stub protruding that is easily grasped and retrieved. This avoids possible trauma and/or surgery to the patient to remove buried implements in or beyond the cortical plate.

Alternately to eliminate the dangers and inefficiency of utilizing a fragile needle tip to deliver the anaesthesia, the inner walls of the funnel can be further prefabricated to contain a circular excavation of the inner walls intended to receive a circular gasket or O-ring type sealing device. This sealing device would prevent the backflow of anaesthesia after a specially designed delivery chamber has been filled under pressure with the deadening fluid. Because the delivery chamber is simultaneously pressing the contact surface of the port against the gum, the fluid would have nowhere to go but down the drilled hole of the cortical plate and into the cancellous tissue underneath. The source of the fluid can be from a typical prior art syringe discharged into the chamber, or from prior art continuous discharge type apparatus commonly termed wand attachments.

### DETAILED DESCRIPTION OF DRAWINGS

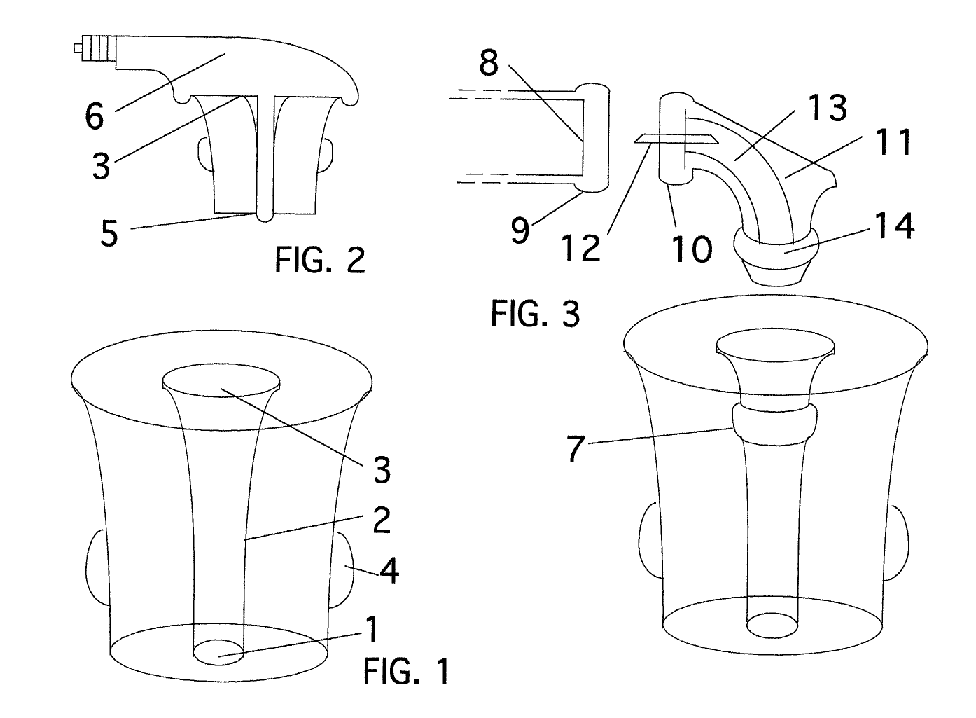

FIG. 1 is a drawing detailing an embodiment of the guidance port where the inner passageway is cylindrical from exit hole 1 to inside position 2. The rest of the passageway flares to entrance hole 3. The entire port is shown as a transparent substance to display the inner structure. Finned anchoring protrusion 4 prevents rotation of the guidance port when the drill bit is spinning. Thus the lower portion which is placed against the gum of the patient contains a guidance canal of sufficient diameter to typically accommodate a twenty five or twenty seven guage drill bit. Overall suggested external dimensions of the entire port would be about three millimeters at the bottom and five millimeters at the top. The depth of the port structure is recommended at about four millimeters.

FIG. 2 is a side perspective of the guidance port of FIG. 1 when in contact with a stylus tip 5 descending from a placement implement 6 through entrance hole 3. The placement implement is loosely in contact with the port in such a manner that when the polyvinyl has set up, it may be withdrawn leaving the port firmly embedded in the indexing material. Also the implement as shown is configured to be screwed into a standard mirror handle, but could alternately have a dedicated handle prefabricated.

FIG. 3 is an exploded view of three items designed to work together in contact. The guidance port is identical to the one in FIG. 1 with the further modification of an inner shallow excavation 7 of a preformed shape perfected to retain a soft O-ring to stop fluid backflow out the entrance orifice. The excavation is actually subtle and is shown much larger than needed to illustrate the principle. The advance tip 8 of a prior art anaesthesia cartridge fits inside a positioning housing whose bushing 9 receives a matched bushing 8 from a special delivery chamber 11. A hollow needle 12 punctures the cartridge at the tip 8 when the two bushings are linked so that fluid enters the inner receptacle 13 and has no exit but out the bottom into the funnel of the guidance port. This is because the O-ring structure 14 of chamber 11 is of such a size that it plugs the excavated region 7 of the guidance port when the two are in contact. When finished, the dentist torques the chamber to either side, which gently pops the O-ring loose and allows the fluid delivery to be ended until later if needed again.

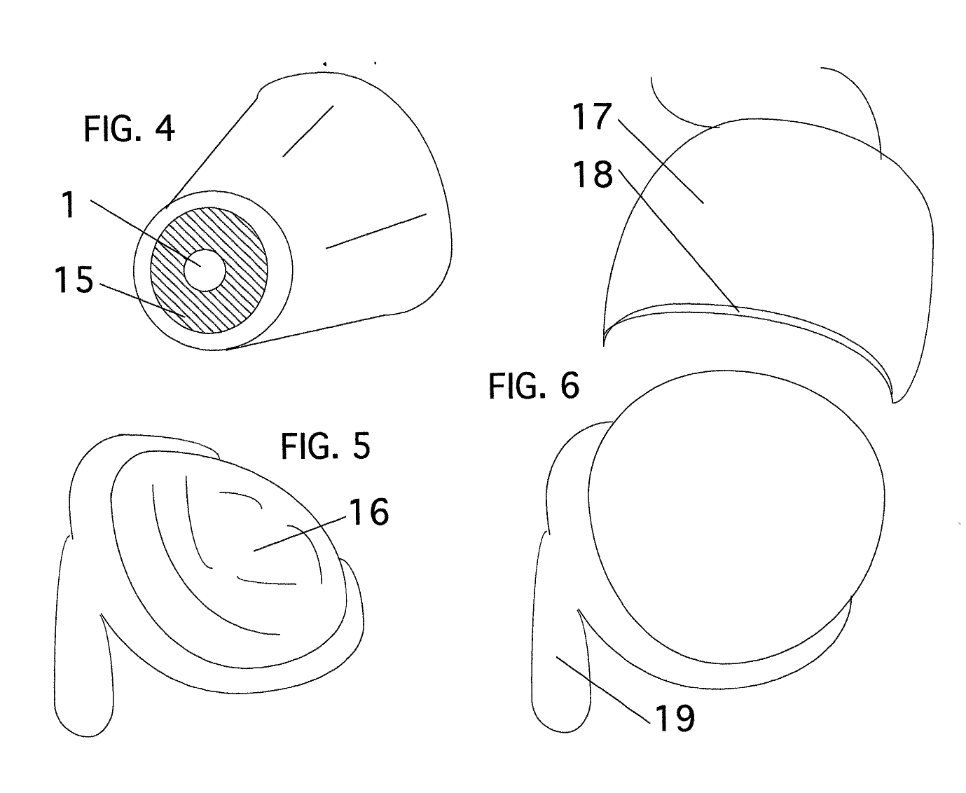

FIG. 4 shows an embodiment of the invention designed to eliminate the embedding of the guidance port in polyvinyl type impression compounds. With an additional circle of temporary adhesive 15 forming a barrier to contain the anaesthesia, the port can be brought or placed against the gum either before or after the drilling of the hole. Then as in FIG. 3 it can serve as a chamber whose inner fluid can be expelled by hydraulic pressure down into and through the bone. The adhesive is durable enough to prevent leakage, but like a bandaid may be twitched loose by the dentist when the job is over. It should be noted that if drilling is to be done through the port, the adhesive must be formulated with sufficient grasping power to withstand the lateral torque transferred to the port by the drill bit itself.

FIG. 5 shows a precursor of the embodiment of FIG. 4 designed solely as a drug delivery means where a hole has already been drilled through the bone. Adhesive holds and positions the outer edge of a circular uninflated igloo 16 ready to be filled with anaesthesia via a needle (not shown). The bottom of the igloo has an opening (not shown) placed above the hole in the bone.

FIG. 6 shows the inflated igloo. The tiny puncture aperture left by the needle is enveloped and thus sealed by a pressure delivering implement 17 that glues itself to the filled igloo chamber with adhesive 18 and forces the fluid down into the bone as required. Withdrawal (not shown) of the pressure delivering implement pulls the igloo chamber off the gumline as a bandaid is pulled off the skin. Should further anaesthesia be needed, the process is repeated. In a scheme where the igloo chamber is not pulled off with the implement, a sturdy dangling strap 19 is there if necessary to be grasped and twitched by the dentist to retrieve the spent igloo chamber. The igloo could (not shown) be interfaced with a wand attachment as a low pressure delivery means to be filled by the wand, which has too high a pressure for direct use.

### CONCLUSION

Although the delivery chamber of FIG. 3 indicates an exit angle into the guidance port of ninety degrees relative to the angle of the cartridge of anaesthesia, a more practical angle would be about one hundred and five degrees. This would allow the dentist to come at the guidance chamber at a more comfortable trajectory. Also whereas a cartridge of anaesthesia is a typical medium of supply, the bushings shown could as easily have been designed to connect to a wand attachment as previously mentioned. This extended angle would also be useful for the placement implement of FIG. 2.

Modifications to the FIG. 5 embodiment would include those having the intent to provide a prefilled igloo chamber that is then positioned on the skin, but these modifications all require a scheme to open the bottom of the igloo chamber to unimpede the desired access of the contained fluid to the hole through the bone. However, practical methods to do this would seem more complicated than is warranted, as the structure and process described are both straightforward and inexpensive to implement. The value of this process is the elimination of a needle being introduced into the bone to deliver the nerve deadening fluid. Also the material used to make the igloo should be a collapsed plastic that inflates to a predetermined volume resembling a turgid blister. Rubber that expands like a balloon further than the required volume is discouraged as a material because when the needle is withdrawn the rubber's pressure will tend to expel fluid out the perforation.

It should be noted that although the embodiment of FIG. 5 holds many of the underlying core concepts of the invention, it itself is not as described the preferred embodiment because of the lack of other features such as the ability to maximize the chances that a broken drill bit will be retrievable.

While presented as an aid in Dental procedures, the invention can find use in other medical fields employing perforations of bone for humans or other species.

This invention should not be confined to the embodiments described, as many modifications are possible to one skilled in the art. This paper is intended to cover any variations, uses, or adaptations of the invention following the general principles as described and including such departures that come within common practice for this art and fall within the bounds of the claims appended herein.

I claim:

1. A delivery device for facilitating the controlled introduction of fluid anaesthesias or medicating liquids through a perforation of the cortical area of the jawbone of humans or other species,
comprising a thin generally flexible substance such as plastic forming a contact surface enclosing an open area, said thin contact surface having at or near the outer extremities a containing igloo of similar but strongly flexible substance and thinness such that said containing igloo is an uninflated blister, said containing igloo totally or partially enclosing the upper surface of said flexible contact surface,
with the lower surface of said flexible contact surface suitable to either be covered with an adhesive similar of purpose to fixiants used to adhere false teeth to gums, or said flexible contact surface as manufactured with said adhesive initially present on a suitable portion of said lower surface,
whereby the utility of said flexible contact surface when adhered to gingiva and said containing igloo when initially punctured and subsequently inflated with a quantity of said anaesthesia or medicating liquids by a needle or like implement is the ability of said igloo to maintain said inflated quantity of said anaesthesia over said perforation in such a manner that an applied exterior generated pressure will effectively force said anaesthesias or medicating liquids through said open area of said contact surface and thus through said perforation for the desired effect.

2. A delivery device as in 1, whereby said thin generally flexible contact surface is not generally flexible and said containing igloo of similar strongly flexible substance is not strongly flexible,
with the shape of said delivery device in a permanent inflated posture due to the increased rigidity of said substance utilized for fabrication,
with said open area of said contact surface continuing upward through the depth of said containing igloo and providing a straight channel entirely through said delivery device.

3. A delivery device as in 2, where said lower surface of said flexible contact surface is devoid of said adhesive,
with the outer circumference of said delivery device bearing a plurality of thin fins running generally parallel to the length of said channel.

4. A delivery device as in 2, with the portion of said channel closest to said contact surface evenly cylindrical in form,
with the portion of said channel furthest from said contact surface of a funnel shape, with the greatest diameter portion furthest away from said contact surface.

5. A delivery device as in 4, with the lateral portions of said delivery device tapered such that said contact surface enclosing said open area of said channel is of a smaller breadth than the distant portion of said delivery device bearing said greatest diameter portion of said channel.

6. A delivery device as in 5, where said smaller breadth of said contact surface is roughly three millimeters, where the breadth of said distant portion is roughly five millimeters, and the distance separating these two locations is roughly from three to six millimeters.

7. A delivery device as in 4, with an intermediate section of said greatest diameter portion further excavated into the fabricating material of said delivery device of a depth and size to allow an external O-ring of designed circumference to snugly fill said intermediate section as a backflow prevention mechanism.

8. A delivery device as in 7, together with a separate prefabricated delivery chamber, said delivery chamber bearing on the furthest end a hollow needle,
said furthest end of said delivery chamber fabricated in the manner of prior art either to couple with an anaesthesia cartridge placed within a dental syringe or to couple with a dental wand attachment,
with the body of said delivery chamber turned at an angle from the path of said hollow needle such that the interface end of said chamber is pointed from ninety to one hundred and twenty degrees away from said path of said hollow needle,
with said interface end fabricated to be of a size and shape to fit snugly inside said funnel shaped portion of said channel and said interface end bearing said external O-ring as the means to fill said intermediate section.

9. A delivery device as in 1, with a thin extension of like composition material as used for said contact surface,
said extension devoid of said adhesive,
said extension connected to the outer edge of said contact surface to provide a means of detachment whereby a dentist may grasp said thin extension and with a twitch remove said delivery device from said gingiva.

10. A delivery device for facilitating the controlled introduction of fluid anaesthesias or medicating liquids through a perforation of the cortical area of the jawbone of humans or other species,
comprising a generally inflexible substance such as plastic forming a contact surface enclosing an open area,
with the lower surface of said flexible contact surface suitable to either be covered with an adhesive similar of purpose to fixiants used to adhere false teeth to gums, or said flexible contact surface as manufactured with said adhesive initially present on a suitable portion of said lower surface,
with said open area of said contact surface continuing upward through the length of said delivery device and providing a channel entirely through said delivery device,
with the portion of said channel closest to said contact surface evenly cylindrical in form,
with the portion of said channel furthest from said contact surface of a funnel shape, with the greatest diameter portion of said channel furthest away from said contact surface,
whereby the utility of said delivery device is the ability when said contact surface is brought in contact with the gum of said cortical area of said jawbone for said delivery device to firstly guide a drill bit for the creation of said perforation and secondly to guide the introduction of said fluid anaesthesias or medicating liquids through said perforation.

11. A delivery device as in 10, where said lower surface of said contact surface is devoid of said adhesive,
with the outer circumference of said delivery device bearing a plurality of thin fins running generally parallel to the length of said channel.

12. A delivery device as in 10, with the outer dimensions of said delivery device tapered such that said contact surface enclosing said open area of said channel is of a smaller breadth than the distant portion of said delivery device bearing said greatest diameter portion of said channel.

13. A delivery device as in 12, where said smaller breadth of said contact surface is roughly three millimeters, where the breadth of said distant portion is roughly five millimeters, and the distance separating these two locations is roughly from three to six millimeters.

14. A delivery device as in 12, with an intermediate section of said greatest diameter portion further excavated into the fabricating material of said delivery device of a depth and size to allow an external O-ring of designed circumference to snugly fill said intermediate section as a backflow prevention mechanism.

15. A delivery device as in 14, together with a separate prefabricated delivery chamber, said delivery chamber bearing on the furthest end a hollow needle,
said furthest end of said delivery chamber fabricated in the manner of prior art either to couple with an anaesthesia cartridge placed within a dental syringe or to couple with a dental wand attachment,
with the body of said delivery chamber turned at an angle from the path of said hollow needle such that the interface end of said chamber is pointed from ninety to one hundred and twenty degrees away from said path of said hollow needle,
with said interface end fabricated to be of a size and shape to fit snugly inside said funnel shaped portion of said channel and said interface end bearing said external O-ring as the means to fill said intermediate section.

16. A method of administering medication through cortical bone, said method comprising the steps of:
deadening the gingiva with a local anaesthesia;
positioning by holding a preformed model in close conjunction with the gingiva over said cortical bone,
introducing uncoagulated registration material over the subject tooth in such a manner that both the tooth and said preformed model are imbedded in said registration material when said material solidifies,
removing said registration material together with said preformed model from the oral cavity and withdrawing said model from said material,
introducing a delivery device into the preformed cavitation in said registration material left by said model, said delivery device containing a straight channel crafted to a desired angle of entry, said channel of a size to accommodate and pass the drill bit of a handheld dental drilling apparatus with the outer end of said channel forming a funnel aperture;
drilling with a bit an opening in said bone through said delivery device;
withdrawing said drill bit and either injecting medication through both said channel and said opening respectively with a hypodermic needle, or pressing the funnel shaped contact end of a delivery chamber predesigned to fit snugly inside said funnel aperture of said channel, with said delivery chamber having the capability to insert under command a quantity of said medication under pressure into said channel and thus on down through said opening in said cortical bone,
withdrawing said hypodermic needle or said delivery chamber and allowing said medication to produce an effect on the patient.

17. A method of administering medication as in 15, wherein the second, fourth, and fifth steps are eliminated by the replacement step of positioning said delivery device in lieu of said preformed model directly against said gingiva by means of a positioning implement and allowing said registration material to encapsulate both said subject tooth and said delivery device, withdrawing said positioning device when said material solidifies, and with the following step of drilling an opening as described.

18. A method of administering medication as in 15, wherein the third, fourth, and fifth steps are eliminated by the alteration of step two to become positioning a delivery device by dedicated adhesion means in close conjunction with the gingiva over said cortical bone, said adhesion means being compounds similar of purpose to fixiants commonly used to adhere false teeth to gums.
